(19) United States
(12) Patent Application Publication
(10) Pub. No.: US 2007/0300091 A1
(43) Pub. Date: Dec. 27, 2007

(54) COMPUTER SYSTEM AND OPTICAL POINTING DEVICE HAVING SECURITY FUNCTION, AND SECURITY METHOD THEREOF

(75) Inventor: Bang-Won LEE, Yongin-si (KR)

Correspondence Address: CANTOR COLBURN, LLP, 55 GRIFFIN ROAD SOUTH, BLOOMFIELD, CT, 06002, US

(73) Assignee: ATLAB INC., Yongin-si (KR)

(21) Appl. No.: 11/743,759

(22) Filed: May 3, 2007

(30) Foreign Application Priority Data
Jun. 26, 2006 (KR) 1020060057587

(51) Int. Cl. G06F 1/00

(52) U.S. Cl. 713/323

(57) ABSTRACT

Provided are a computer system having a security function, a computer security method, and an optical pointing device. The optical pointing device includes: an optical part irradiating light to a worktable surface and transmitting the light reflected; receiving the reflected light to continuously detect an image and detect a motion of the optical pointing device using variation of the image, and calculating a motion value to output motion data; a first transparent plate receiving the reflected light to discharge the light to the exterior; a second transparent plate transmitting the light discharged and reflected from the subject into the optical pointing device; a subject motion sensor receiving the light reflected from the subject to detect a motion of the subject, and outputting subject motion data; and a motion data storage part storing the motion data and the subject motion data.

### CROSS-REFERENCE TO RELATED APPLICATION

This application claims the benefit of Korean Patent Application No. 2006-57587, filed Jun. 26, 2006, the disclosure of which is hereby incorporated herein by reference in its entirety.

### BACKGROUND OF THE INVENTION

1. Field of the Invention

The present invention relates to a computer system and an optical pointing device having a security function, and a security method thereof, and more particularly, to a computer system and an optical pointing device, and a security method thereof capable of preventing access of an invader to a host computer by mounting a motion sensor on the host computer itself or a computer input device, and performing a security function of the computer by recording motion data of a subject using a conventional light source.

2. Description of the Related Art

With complex and rapid variation of a modern society, a necessity for protection and observation of human or technical resources has been remarkably increased. Therefore, importance of a video security system is also increasing day by day. Especially, in order to observe visitors of enterprises, public offices, banks, and so on, and obtain evidences, utilization of a video security system is being remarkably increased.

An observation performance of the video security system may be represented as automatic tracking of the system and an image obtained by the system. The automatic tracking is proposed to solve a problem of an early security and observation system in which an observation area is gradually widened and complicated, and an observer should watch all of the observation areas.

For example, in an invader observation and automatic tracking system, when a motion of an invader is detected in an observation area, an automatic alarm is provided and the invader is automatically tracked. The automatic tracking is now essential to satisfy observation requirements of numerous observation areas of the complicated modern society.

A conventional video security system includes a large number of stationary cameras for monitoring a large number of observation areas to observe an invader. However, it is difficult to accomplish an automatic observation system for detecting a motion of the invader and tracking the invader using the conventional video security system.

Specifically, while the video security system using a large number of stationary cameras can detect a motion of a subject within a limitative viewing angle of each stationary camera, it is almost impossible to accomplish an automatic motion detecting function of the observation system, especially, an automatic motion tracking function.

In addition, the conventional video security system uses a method of photographing and recording a large area using a stationary camera. For example, a closed circuit television (CCTV) camera photographs an observation area, and the photographed image is output on a monitor to allow a user to observe the area. Then, the image data are recorded by a video tape recorder (VTR) to be stored and used as evidences in the future.

FIG. 1 is a schematic block diagram of an image and sound data recording system of a conventional CCTV recording system using a conventional VTR. The system includes a CCTV camera 30, a monitor 60, an observer 80, a VTR 70, a host computer 40, a computer input device 45, and a subject 50. In this process, enterprise or private secret data are stored in the host computer 40, and the subject 50 includes an authorized user accessible to the host computer 40, and an illegal user or an invader.

Hereinafter, the operation of a computer security system using a conventional CCTV recording system will be described with reference to FIG. 1.

The CCTV camera 30 is installed at a predetermined observation area requiring a video security system, in which the host computer 40 containing security data is disposed. The CCTV camera 30 automatically operates when a user or a manager is not in the office at night or day to photograph an image and sound of a motion of the subject 50 in the observation area as time goes.

The photographed image and sound information is transmitted through a transmission device (not shown) to the monitor 60 in a predetermined remote observation area including a remote observation control system.

The observer 80 in the observation area watches the image and sound information transmitted from the CCTV camera 30 to the monitor 60 to observe the corresponding area in real time.

While observing the corresponding area, the observer 80 transmits the image and sound date to the VTR 70 and records the data in order to reproduce the data in the future or use the data as legal evidences.

However, when a tape is used as a recording medium, image quality of the tape may be deteriorated due to repeated uses. In addition, a record time of the tape is less than about 6 hours even in a low resolution mode, and a separate storage space and a manager for storing and managing a large amount of tapes are required, thereby causing high maintenance cost.

In addition, a personal computer has a screen saver function for preventing another person from watching a computer monitor when there is no input from a computer input device for a predetermined time. However, since the screen saver is operated only when a predetermined time elapses, when an illegal user operates the computer input device just after an authorized user leaves the seat, the screen saver is not operated to make the computer security system useless.

Meanwhile, a conventional passive motion sensor for detecting a motion of a subject such as a human body accumulates infrared light for a predetermined time to compare variations of the amount of infrared light to recognize a motion or an access of a moving body in front of the sensor. The passive motion sensor has been widely used to detect a motion in the office after leaving the office. Recently, an active motion sensor has come into the market, which includes a light source for directly irradiating light to a subject and detecting a motion of the subject using the light reflected from the subject, in addition to the passive motion sensor.

FIG. 2 illustrates a conventional optical mouse, which includes a light source 8, a lens 5, and a mouse motion sensor 20. Reference numeral 2 represents a worktable surface, and 4, 6 and 7 represent light.

In the optical mouse shown in FIG. 2, the light 7 emitted from the light source 8 is reflected from the worktable surface 2, and the reflected light 6 passes through the lens 5. Then, the light 4 passed through the lens 5 is input into the mouse motion sensor 20. The mouse motion sensor 20 continuously detects an image of the worktable surface 2 to recognize a motion of the optical mouse using variation of the image, calculates the motion value, and controls ON/OFF of the light source 8.

FIG. 3 is a block diagram of a conventional optical mouse including an optical part 10, and a mouse motion sensor 20. The mouse motion sensor 20 includes an image sensor 22, and a controller 24.

Hereinafter, functions of the blocks shown in FIG. 3 will be described with reference to FIGS. 2 and 3.

The optical part 10 includes the light source 8, the lens 5, and other attachments. The light source 8 irradiates light onto the worktable surface 2, and the light reflected from the worktable surface 2 is transmitted to the image sensor 22 in the mouse motion sensor 20 through the lens 5. The mouse motion sensor 20 calculates a motion value MOV using an optical image transmitted through the optical part 10 to output the motion value MOV, and outputs a control signal CON for controlling the light source of the optical part 10. The image sensor 22 receives the reflected light through the lens to detect an image, and outputs image information IM of the detected image. The controller 24 calculates the motion value MOV using the image information IM, and outputs a control signal CON for controlling ON/OFF of the light source 8 depending on the operation state of the optical mouse.

In order to fabricate the active motion sensor as described above, when a separate light source is added to the passive motion sensor to improve performance thereof, manufacturing cost may be increased and an internal circuit may also be complicated due to the separate light source and electrical and optical components related thereto. When the active motion sensor is adapted to a conventional optical mouse, it is disadvantageous in cost and size and unmarketable to add the separate light source and the electrical or optical components related thereto to a compact optical mouse having a simple circuit structure.

### SUMMARY OF THE INVENTION

The present invention provides a computer system capable of preventing degradation of image quality due to deterioration of a video security system through recording media, limitation of a record time, and waste of maintenance cost due to storage of the recording media, and performing a host computer security function by installing a subject motion sensor in a host computer or a computer input device to detect the time when an input signal used in a conventional screen saver is not input and the time when a user leaves the computer.

The present invention also provides a host computer security method capable of performing the above functions.

The present invention also provides an optical pointing device capable of preventing complication of a circuit and increase in manufacturing cost due to addition of an electrical or optical component by utilizing its own light source, and performing a host computer security function by installing a subject motion sensor therein.

According to an aspect of the present invention, a computer system having a security function includes: a host computer for operating a first security program when motion data of a subject is received in a non-operation state that power is applied and a computer does not operate and for operating a second security program when motion data of a subject is not received in a operating state that power is applied; a computer input device for applying an input signal to the host computer to perform an operation corresponding thereto; and a subject motion sensor for detecting a motion of the subject to output motion data of the subject.

According to another aspect of the present invention, a computer security method includes: a first step of determining whether a host computer currently operates in a state that power is applied to the host computer; a second step of determining that the host computer does not currently operate in the first step and operating a subject motion sensor to determine whether a motion of a subject is detected, when the power is applied to the host computer and the host computer does not operate for a predetermined time; and a third step of operating the host computer to operate a first security program when the motion of the subject is detected.

The computer security method may further include: a fourth step of determining that the host computer currently operates and determining whether an input signal is input into the host computer from a computer input device, when power is applied to the host computer and the host computer operates in the first step; a fifth step of receiving an input signal and performing an operation in response to the signal when it is determined that the input signal is input into the host computer in the fourth step; and a sixth step of operating the subject motion sensor to determine whether a motion of the subject is detected when there is no input signal in the fourth step.

The computer security method may further include a seventh step of feeding back to the fourth step when the motion of the subject is detected in the sixth step, and feeding back to the fourth step after operating a second security program when the motion of the subject is not detected in the sixth step.

According to still another aspect of the present invention, an optical pointing device includes: an optical part for irradiating light to a worktable surface using a light source and transmitting the light reflected from the worktable surface; a motion sensor for receiving the reflected light to continuously detect an image of the worktable surface and detect a motion of the optical pointing device using variation of the image, and calculating a motion value to output motion data; a first transparent plate for simultaneously receiving the reflected light to discharge the light to the exterior of the optical pointing device; a second transparent plate for transmitting the light discharged from the first transparent plate and reflected from the subject into the optical pointing device; a subject motion sensor for receiving the light reflected from the subject through the second transparent plate to detect a motion of the subject, and outputting subject motion data; a motion data storage part for receiving the motion data and the subject motion data and storing the data; and a wireless data transmission and reception part for receiving a motion data transmission request from the host computer, and receiving the data stored in the motion data storage part to transmit the data to the host computer.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 is a block diagram of a conventional system having a computer security function using a CCTV record system;

FIG. 2 is a schematic view of a conventional optical mouse;

FIG. 3 is a block diagram of a conventional optical mouse outputting mouse motion data;

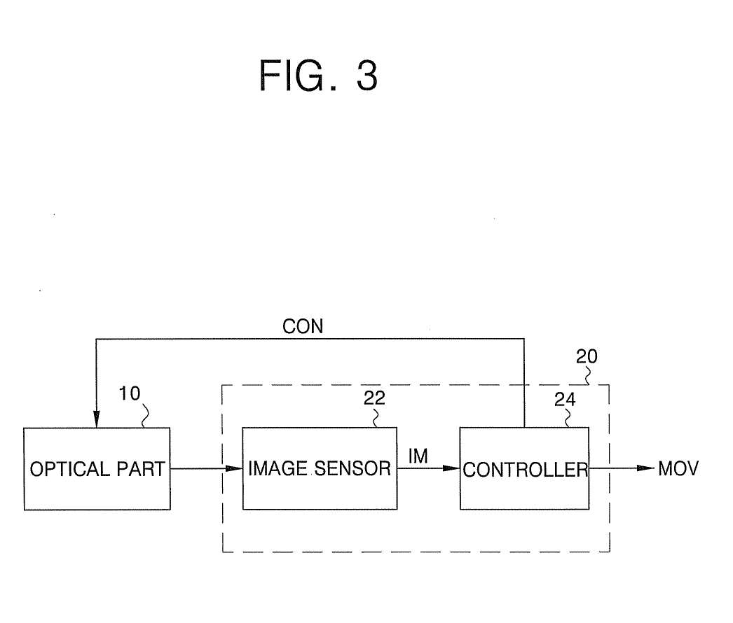

FIG. 4A is a block diagram of a computer system including a subject motion sensor having a computer security function and installed in a host computer in accordance with a first exemplary embodiment of the present invention;

FIG. 4B is a block diagram of a computer system including a subject motion sensor having a computer security function and installed in a computer input device in accordance with a second exemplary embodiment of the present invention;

FIG. 5 is a flowchart illustrating a security method of a computer system including a subject motion sensor having a computer security function and installed in a host computer or a computer input device;

FIG. 6 is a schematic view of a computer system including a subject motion sensor having a computer security function and installed in a wireless optical mouse in accordance with a third exemplary embodiment of the present invention;

FIG. 7 is a block diagram of a computer system including a subject motion sensor having a computer security function and installed in a wireless optical mouse in accordance with a third exemplary embodiment of the present invention; and

FIG. 8 is a flowchart illustrating a process of installing a motion sensor having a computer security function into the wireless optical mouse.

### DETAILED DESCRIPTION OF THE INVENTION

Reference will now be made in detail to the embodiments of the present invention, examples of which are illustrated in the accompanying drawings, wherein like reference numerals refer to the like elements throughout.

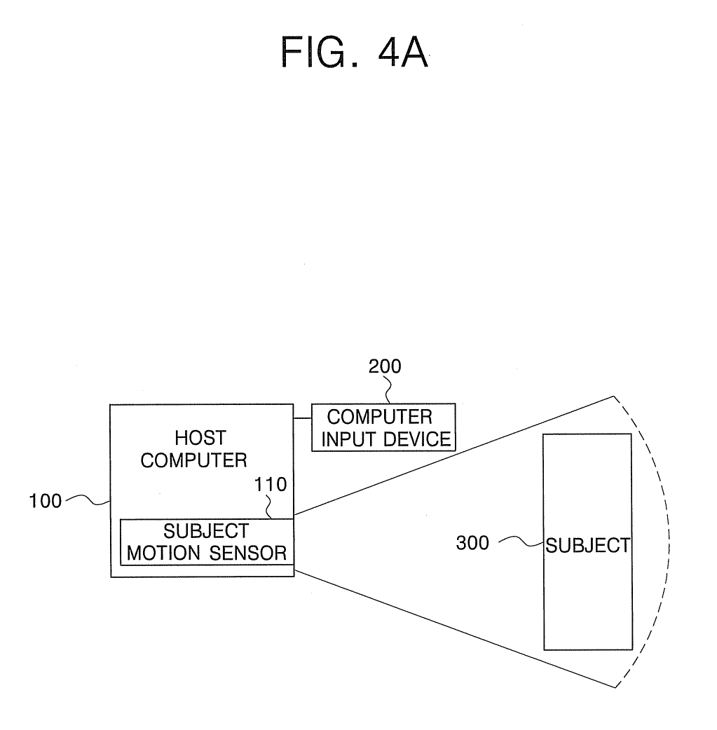

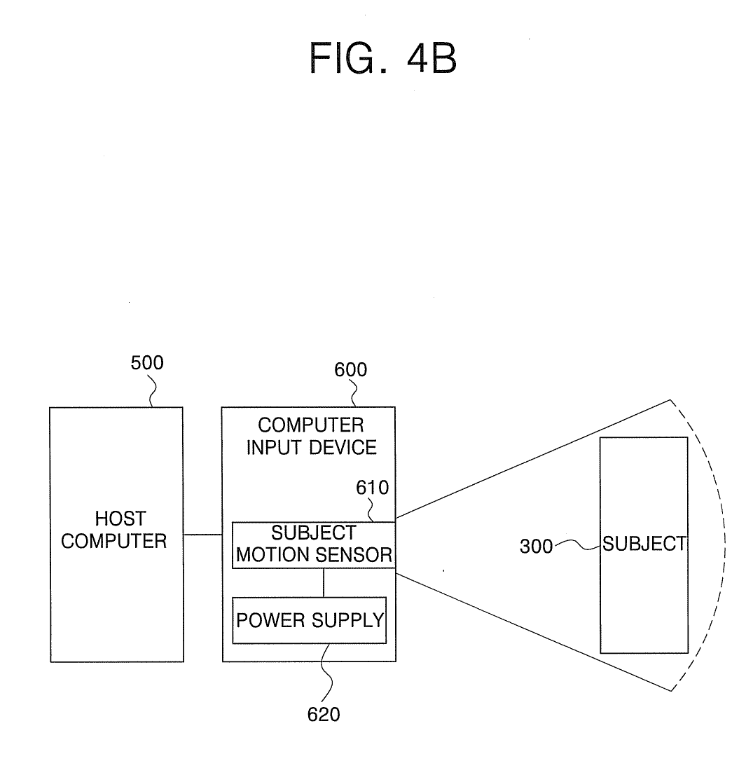

FIG. 4A is a block diagram of a computer system including a subject motion sensor having a computer security function and installed in a host computer in accordance with a first exemplary embodiment of the present invention. The computer system includes a host computer 100 and a computer input device 200. Reference numeral 300 represents a subject. The host computer 100 includes a subject motion sensor 110.

FIG. 4B is a block diagram of a computer system including a subject motion sensor having a computer security function and installed in a computer input device in accordance with a second exemplary embodiment of the present invention. The computer system includes a host computer 500 and a computer input device 600. Reference numeral 300 represents a subject. The computer input device 600 includes a subject motion sensor 610 and a power supply 620. Unlike the first embodiment of FIG. 4A, the subject motion sensor 610 is installed in the computer input device 600 such as a mouse, a keyboard, a PC video communication camera, and so on, rather than installed in the host computer 500. In addition, the power supply 620 is installed in the computer system to supply a power voltage to the subject motion sensor 610 even when power is not supplied to the computer system.

Hereinafter, the operation of the respective blocks when a subject motion sensor having a computer security function in accordance with the present invention is installed in a host computer or a computer input device will be described with reference to FIGS. 4A and 4B.

Generally, the state of the host computer is classified as an operation state and a non-operation state depending on an active mode or a standby mode of a central processing unit installed in the host computer. The operation state is divided into a working mode, a sleep mode, and a wake-up mode according to whether an input signal is applied from the computer input device within a predetermined time while the central processing unit is in the active mode.

When an input signal is applied from the computer input device 200 or 600 such as a keyboard or a mouse in a state that the power of the host computer 100 or 500 is applied, the host computer is in the working mode. However, when an input signal is not applied from the computer input device 200 or 600 even though a predetermined time elapses, the host computer is shifted to a sleep mode to perform an operation such as a screen save mode of a computer monitor.

The non-operation state of the host computer 100 or 500 means that the central processing unit is in a standby mode to save power consumption and rapidly re-boot the computer system when the computer does not operate for a long time while the power is applied.

At this time, even though the power is applied to the host computer 100 or 500 and an input signal is not applied from the computer input device 200 or 600 for a predetermined time to be shifted to a non-operation state such as a sleep mode or a standby mode, the subject motion sensor 110 or 610 installed in the host computer 100 or the computer input device 600 operates.

When a motion of the subject 300 is detected within a proximity range of the host computer 100 or 500 under a non-operation state of the powered host computer 100 or 500, i.e., a standby state, the host computer 100 or 500 determines as an operation of the host computer 100 or 500 by an illegal intruder, and thus operates a first security program. For example, when a motion of the subject 300 is not detected within the proximity range of the host computer 100 or 500 by the subject motion sensor 110 or 610 in a state that the power is applied and the host computer 100 or 500 is in a sleep mode, the host computer 100 or 500 determines that an operator stops the computer operation and leaves the seat, and thus operates a second security program. For example, the host computer 100 or 500 may limit data transmission/reception through a network such as the Internet by an illegal user or a hacker, or set a password for preventing access to the host computer 100 or 500 through the network by remotely logging in the host computer.

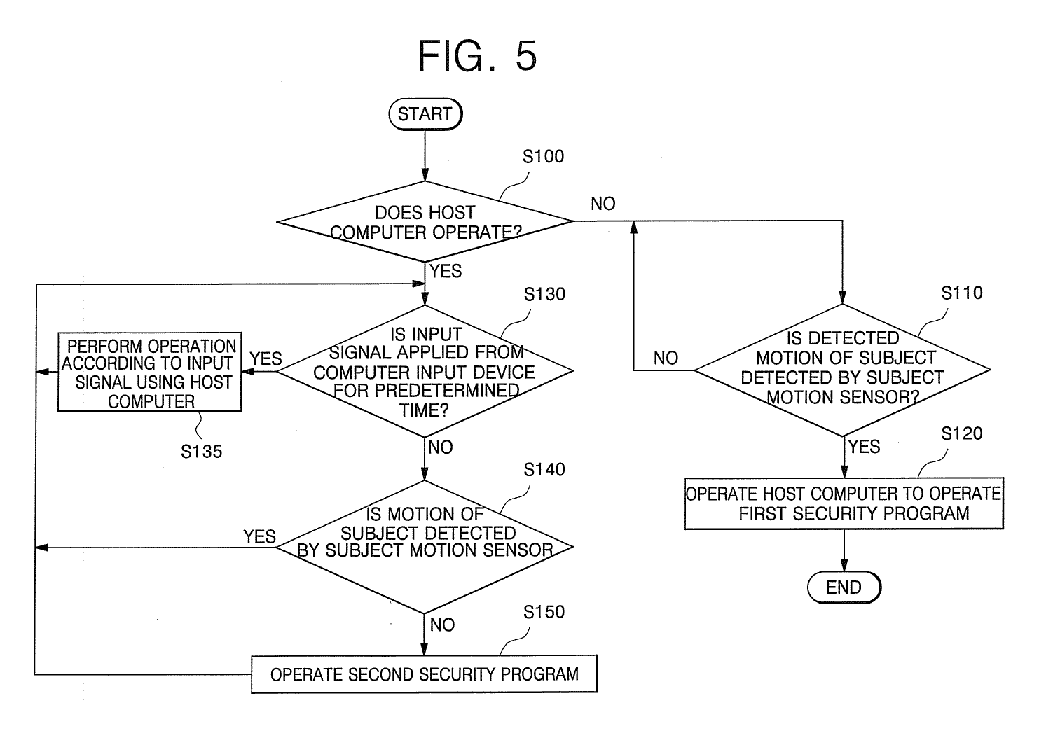

FIG. 5 is a flowchart illustrating a security method of a computer system including a subject motion sensor having a computer security function and installed in a host computer or a computer input device.

It is determined whether the host computer currently operates according to whether the central processing unit in the host computer is in an active mode in a state that the power is applied to the host computer (S100).

When the power is applied to the host computer and the computer system does not operate for a predetermined time, the subject motion sensor installed in the host computer or the computer input device operates to determine whether a motion of a subject is detected (S110).

When a motion of the subject is detected by the subject motion sensor, the computer system operates a first security program and determines that an illegal user operates the host computer to initiate the host computer, and operates a first security program (S120).

When the power is applied to the host computer and the host computer currently operates, the host computer determines whether an input signal is applied from the computer input device (S130).

When the host computer determines that the input signal is applied from the computer input device, the host computer receives the input signal to perform an operation corresponding thereto (S135), and feeds back to step S130 to determine whether another input signal is applied from the computer input device (S130).

When an input signal is not applied from the computer input device for a predetermined time, the host computer is shifted to a sleep mode and a subject motion sensor installed in the host computer or the computer input device operates to determine whether a motion of the subject is detected (S140).

When the subject motion sensor detects a motion of the subject, the computer system determines that an authorized user operates the host computer to be fed back to step S130, and then determines whether another input signal is applied from the computer input device (S130).

When the subject motion sensor does not detect a motion of the subject, the currently operated host computer operates a second security program in order to prevent connection to the host computer by an illegal intruder through the computer network (S150).

Then, the host computer is fed back to step S130 and is on standby in order to determine whether another signal is applied from the computer input device (S130).

Hereinafter, operation flow of the subject motion sensor having a computer security function and installed in the host computer or the computer input device will be described.

For example, on the assumption that an authorized user leaves the seat of the host computer for a long time, it is determined whether the host computer currently operates according to the active or non-active state of the central processing unit in a state that the power is applied to the host computer (S100). When the power is applied to the host computer and the computer system does not operate for a long time, for example, the computer system is in a standby mode for reducing power consumption and rapid re-booting of the computer system, the host computer or the computer input device recognizes that the authorized user completes the computer operation and operates the subject motion sensor installed therein (S110).

When an illegal intruder moves in front of the host computer or approaches to the host computer, the subject motion sensor installed in the host computer or the computer input device detects the motion of the subject to operate the host computer and then operate the first security program (S120). In this process, the first security program may include informing illegal intrusion into the host computer to a security system company through the network.

When there is no motion or access in front of the host computer by an illegal intruder, the computer system is fed back to step S110 and is on standby in order to determine whether another motion or access in the proximity region is detected by the subject motion sensor (S110).

When the power of the host computer is turned ON and the computer operates, for example, the computer is in a screen save mode, the host computer determines that the authorized user does not yet complete the computer operation and determines whether an input signal is applied from the computer input device (S130). At this time, when the host computer was in the active mode or an input signal is applied from the computer input device during the sleep mode, the host computer is in the wake-up mode to receive the input signal and perform an operation corresponding thereto (S135).

For example, when a predetermined input is applied from the keyboard or the mouse, the screen save mode is released, and a response corresponding thereto is displayed on a computer monitor, a printer, or the like. Then, the computer system is fed back to step S130 and is on standby in order to determine whether an input signal is applied from the computer input device (S130).

When there is no signal from the computer input device for a predetermined time, the host computer is shifted to the sleep mode to operate the subject motion sensor, similar to that the host computer is in the non-operation state (S140).

When a motion of the subject is detected by the subject motion sensor, the host computer determines that an illegal user moves in front of the host computer in a state that the computer operation is not still completed, and is fed back to step S130 and is on standby in order to determine whether an input signal is applied from the computer input device (S130).

On the other hand, there in no motion of the subject detected by the subject motion sensor, the host computer determines that the authorized user completes the computer operation and leaves the seat and operates the second security program for preventing access to the host computer by an illegal intruder through the computer network (S150). That is, the host computer may limit data transmission/reception through a network such as the Internet by an illegal user or a hacker, or set a password for preventing access to the host computer through the network by remotely logging in the host computer.

Then, the host computer is fed back to step S130 and is on standby in order to determine whether an input signal is applied from the computer input device (S130).

As described above, when the subject motion sensor having a computer security function is installed in the host computer or the computer input device, the host computer can perform the security program for preventing illegal access to the host computer in a predetermined observation region or a computer network by an illegal intruder when the authorized user leaves the seat for a long time, thereby preventing waste of maintenance cost and manpower due to degradation of image quality by deterioration of the video security system, limitation of a record time, and storage of recording media.

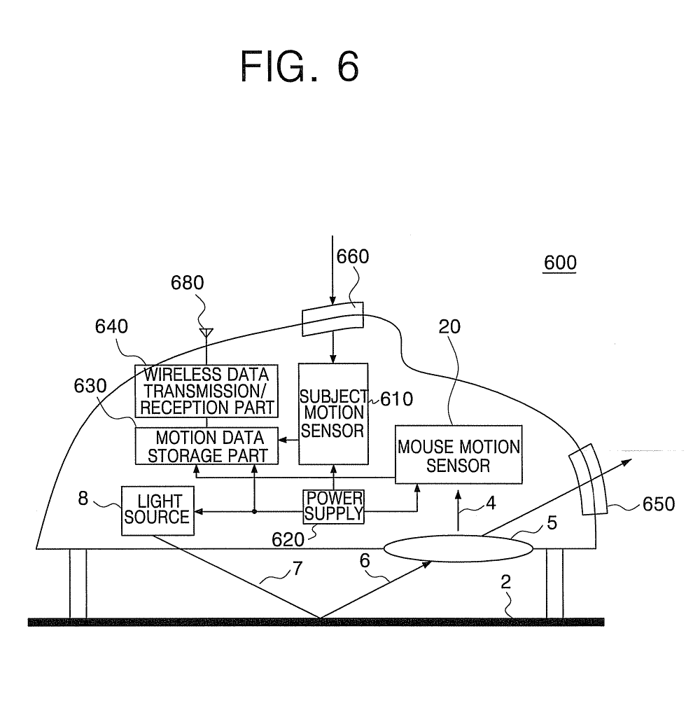

Next, FIG. 6 is a schematic view of a computer system including a subject motion sensor having a computer security function and installed in a wireless optical mouse in accordance with a third exemplary embodiment of the present invention. The optical mouse in accordance with the present invention includes a light source 8, a lens 5, a mouse motion sensor 20, a subject motion sensor 610, a motion data storage part 630, a wireless data transmission/reception part 640, a power supply 620, a light emitting transparent plate 650, a light receiving transparent plate 660, and an antenna 680.

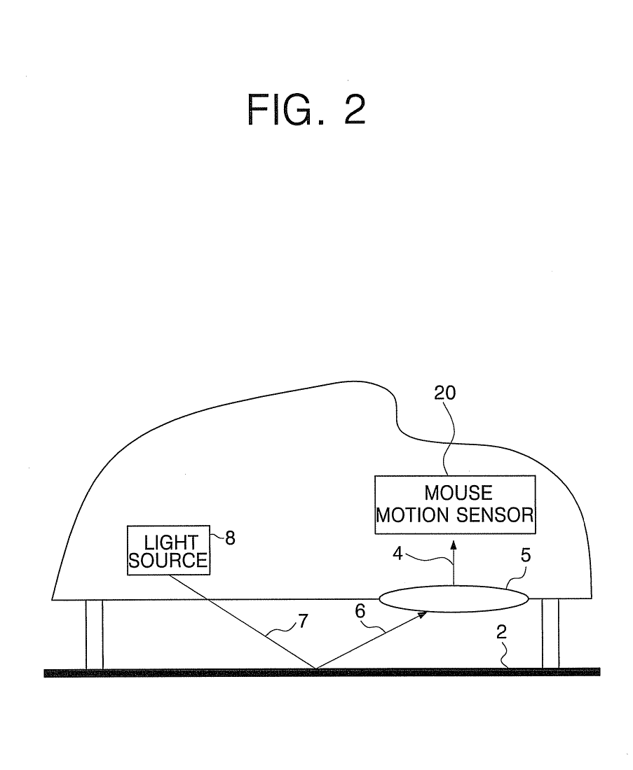

Since connections and functions of components of the light source 8, the lens 5, and the mouse motion sensor 20 are similar to the conventional optical mouse of FIG. 2, their descriptions will not be repeated, and connections and functions of added components will be described.

Light 4 passed through the lens 5 is projected to the mouse motion sensor 20 and the light emitting transparent plate 650 to be emitted to the exterior of the wireless optical mouse.

The subject motion sensor 610 receives the light reflected from the subject (not shown) entering from the exterior of the wireless optical mouse through the light receiving transparent plate 660 to detect the approach or motion of the subject.

The motion data storage part 630 respectively receives mouse motion data and subject motion data from the mouse motion sensor 20 and the subject motion sensor 610 to temporarily store the data until transmission is requested from the host computer.

The wireless data transmission/reception part 640 receives a motion data transmission request through the wireless antenna 680 from the host computer, obtains a motion value calculated by the mouse motion sensor 20 or motion data detected by the subject motion sensor 610 and the mouse motion sensor 20 stored in the motion data storage part 630, and converts the data into an analog signal to transmit the analog signal to the host computer through the antenna 680. In this process, when the wireless data transmission/reception part 640 has a unidirectional communication function, i.e., only a transmission function, information stored in the motion data storage part 630 is repeatedly transmitted together with the motion data of the mouse, and the host computer disregards the information when the repeated information is input.

Here, the light source 8 can be invisible to protect eye disturbance. And transparent plates 650 and 660 can be optical filter to pass only the light spectrum from the light source 8.

The power supply 620 supplies power to all components of the wireless optical mouse such that the components are normally operated, even though a power voltage is not applied to the host computer.

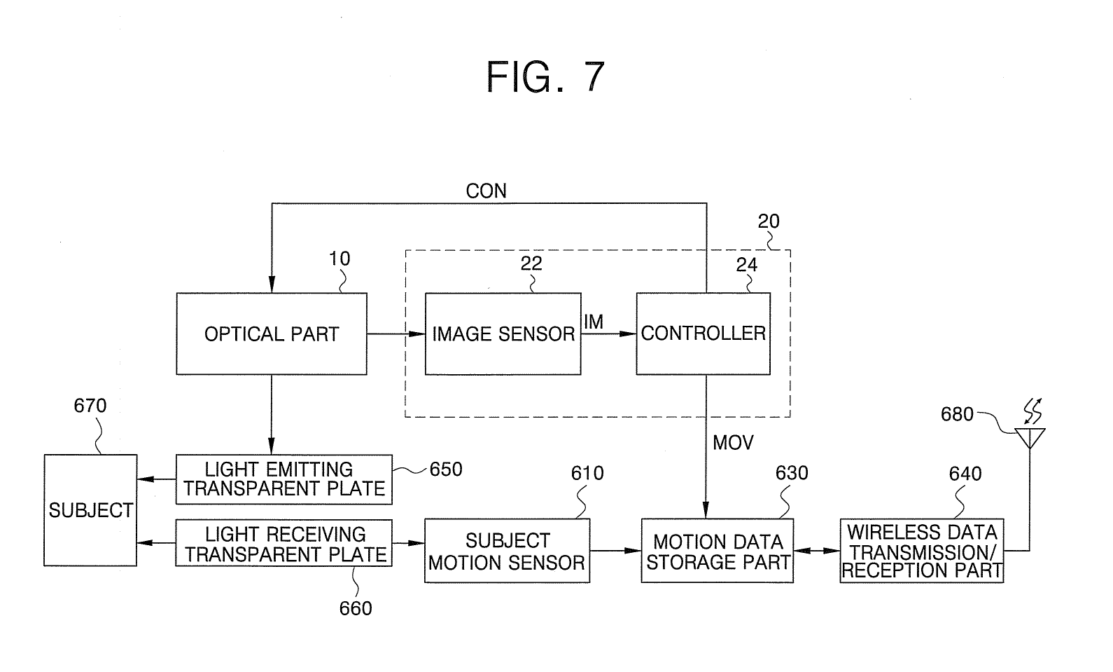

FIG. 7 is a block diagram of a computer system including a subject motion sensor having a computer security function and installed in a wireless optical mouse in accordance with a third exemplary embodiment of the present invention. The wireless optical mouse includes an optical part 10, a mouse motion sensor 20, a subject motion sensor 610, a motion data storage part 630, a wireless data transmission/reception part 640, a light emitting transparent plate 650, a light receiving transparent plate 660, and an antenna 680. Reference numeral 670 represents a subject.

Since constitutions and functions of the optical part 10 and the mouse motion sensor 20 are similar to the conventional optical mouse of FIG. 2, their descriptions will not be repeated. However, different from FIG. 2, light from the optical part 10 is simultaneously applied to an image sensor 22 and the light emitting transparent plate 650. In addition, a motion value MOV calculated and output from a controller 24 is output to the motion data storage part 630, rather than the exterior of the wireless optical mouse.

In addition, the light applied to the light emitting transparent plate 650 from the optical part 10 is projected to the subject 670, and the light reflected from the subject 670 passes through the light receiving transparent plate 660 to be applied to the subject motion sensor 610. The subject motion sensor 610 detects the approach or motion of the subject 670 according to variation of the reflected light of the subject 670, and then outputs motion data of the subject 670. In this process, the subject motion sensor 610 may use a photodiode for receiving only a frequency of the light source used in an optical mouse in order to increase precision of the motion sensor using the same frequency as its own light source, in comparison with an infrared motion sensor widely used for security applications.

The motion data storage part 630 receives a mouse motion value MOV output from the controller 24 and motion data of the subject 670 output from the subject motion sensor 610 to temporarily store the data. The wireless data transmission/reception 640 receives the data from the motion data storage part 630 to transmit the data to the host computer through the antenna 680, when transmission is requested from the host computer.

Hereinafter, operation of the wireless optical mouse including the subject motion sensor 610 having a computer security function will be described with reference to FIGS. 6 and 7.

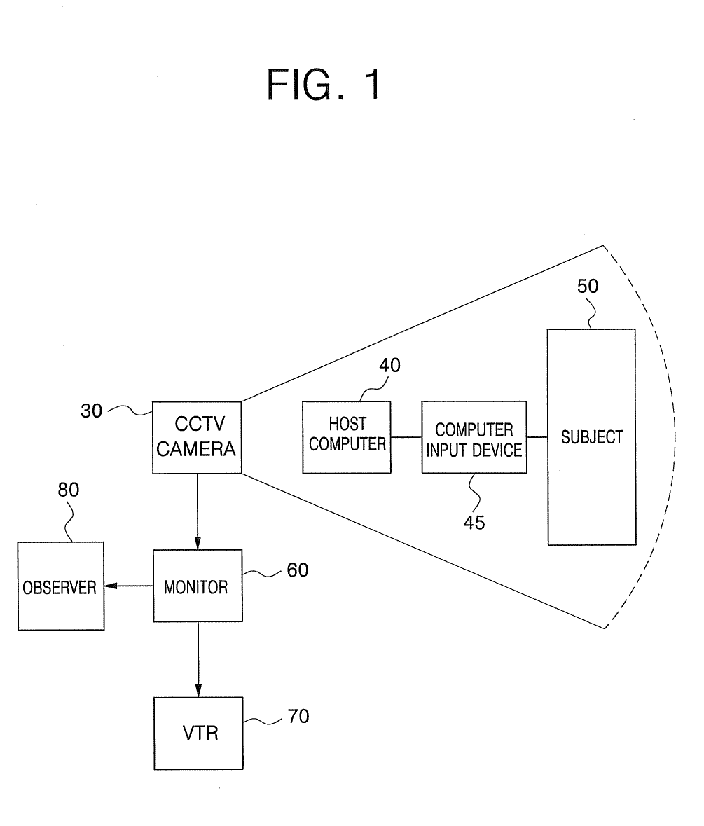

Light 7 emitted from the light source 8 is reflected from a worktable surface 2, and reflected light 6 passes through the lens 5, similar to the conventional optical mouse of FIG. 1. However, the light 4 passed through the lens 5 is projected to the mouse motion sensor 20 and the light emitting transparent plate 650 to be emitted to the exterior of the wireless optical mouse.

At this time, when the subject 670 is exposed to the light emitted from the exterior of the wireless optical mouse at a distance adjacent to the wireless optical mouse, the light is partially absorbed and partially reflected after colliding with the subject 670 to enter the wireless optical mouse through the light receiving transparent plate 660.

The subject motion sensor 610 receives the reflected light re-entering through the light receiving transparent plate 660 to detect the approach or motion of the subject 670 in the proximity region, thereby outputting motion data such as a moved time and a consumed time of the subject 670. The motion data storage part 630 receives the mouse motion data from the mouse motion sensor 20 and receives the subject motion data from the subject motion sensor 610 and temporarily stores the data.

A user of the host computer requires the wireless optical mouse to provide the mouse motion data and the motion data of the subject 670 approached or moved within the proximity region of the host computer while the user leaves the seat.

The wireless data transmission/reception part 640 receives the requirement of the host computer through the antenna 680, and converts the digital information stored in the motion data storage part 630 into an analog signal and transmits the analog signal to the host computer through the wireless antenna 680.

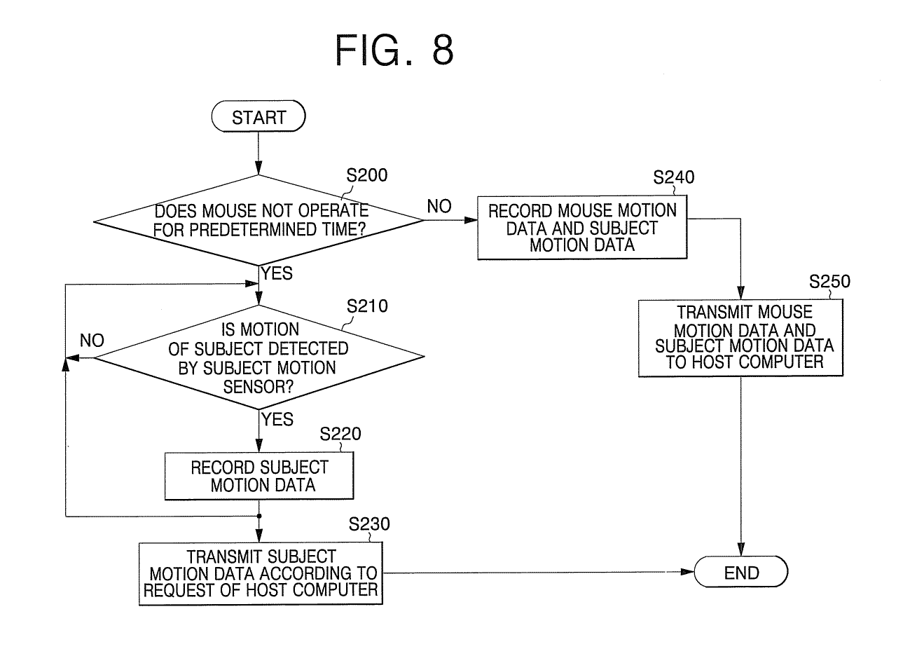

FIG. 8 is a flowchart illustrating a process of installing a motion sensor having a computer security function into the wireless optical mouse.

A mouse motion sensor continuously detects an image of a worktable surface to determine whether the wireless optical mouse moves within a predetermined time on the base of variation of the image (S200).

When the wireless optical mouse is not moved within a predetermined time, the subject motion sensor determines whether the subject moves or approaches in front of the wireless optical mouse (S210).

When a motion or approach of the subject is detected by the subject motion sensor, subject motion data is recorded in the motion data storage part (S220), and then fed back to step S210 and is on standby to determine whether another motion or approach within the proximity distance is detected by the subject motion sensor (S210).

When the host computer requires transmitting the subject motion data, the wireless optical mouse transmits the subject motion data recorded in the motion data storage part to the host computer in a wireless manner (S230).

When a motion of the subject is not detected by the subject motion sensor during step S210, the host computer stands by to determine whether another motion or approach is detected by the subject motion sensor (S210).

When the wireless optical mouse is moved within a predetermined time during step S200, since it means that the subject also moves, the motion data storage part records mouse motion data and subject motion data and temporarily stores the data (S240).

When the host computer requires the motion data, the wireless data transmission/reception part in the wireless optical mouse transmits the motion data stored in the motion data storage part to the host computer in a wireless manner (S250).

Operation of the wireless optical sensor including the motion sensor having a computer security function in accordance with the present invention will be described with reference to FIG. 8.

For example, on the assumption that an authorized user leaves the seat of the host computer for a long time, since there is no input by the optical wireless mouse, the mouse motion sensor determines that the wireless optical sensor is not moved for a predetermined time (S200).

In addition, since the subject motion sensor continuously operates regardless of whether or not an input operation is performed by the wireless optical mouse, the host computer determines that there is no motion or approach of a user in front of the wireless optical mouse, and is loop-circulated and on standby to determine whether another motion or approach within the proximity distance is detected by the subject motion sensor (S210).

At this time, when an illegal intruder moves or approaches within the proximity distance in front of the host computer, the subject motion sensor installed in the wireless optical mouse detects the motion or approach to record motion data such as a moved time and a consumed time of the subject in the motion data storage part (S220).

When there is no motion or approach with the proximity distance of the host computer by the illegal intruder, the host computer is fed back to step S210 and is on standby to determine whether another motion or approach within the proximity distance is detected by the subject motion sensor (S210).

Then, when the host computer requires the wireless optical mouse to provide motion data information within the proximity distance in front of the host computer after the authorized user comes back to the seat to re-start the computer operation, the motion data storage part in the wireless optical mouse transmits the stored motion data detected by the subject motion sensor to the host computer through the antenna (S230).

When an input operation of the wireless optical mouse is performed by the illegal intruder while the authorized user leaves the seat for a long time, the mouse motion sensor detects that the wireless optical mouse is moved within a predetermined time (S200), and calculates the motion value and outputs the motion value. In this case, the motion data storage part records the mouse motion data and stores the mouse motion data until the host computer requires the data.

At this time, since the illegal intruder moves or approaches within the proximity distance in front of the host computer in order to perform an input operation using the wireless optical mouse, the subject motion sensor installed in the wireless optical mouse detects the motion or approach to record the subject motion data in the motion data storage part (S240).

Then, when the host computer requires the wireless optical mouse to provide the use time information of the wireless optical mouse and the motion data information in front of the host computer while the authorized user leaves the seat after the authorized user comes back to the seat to re-start the computer operation, the motion data storage part in the wireless optical mouse transmits the subject motion data detected by the subject motion sensor and the mouse motion data detected by the mouse motion sensor, which are stored therein, to the host computer through the antenna (S250).

As described above, when the motion sensor having a computer security function is installed in the optical mouse, motion data of the subject is recorded and stored using a conventional light source and transmitted to the host computer, thereby preventing complication of a circuit and increase of manufacturing cost due to addition of separate electrical or optical components.

In addition, the power supply and the subject motion sensor are installed in the computer input device, even when the power voltage is not applied to the host computer, the power supply supplies power to the computer input device to normally operate all components in the wireless optical mouse.

While the present invention describes the wireless optical mouse including the subject motion sensor having a computer security function as an example of the computer input device, the computer input device may be a keyboard, a PC video communication camera, a computer monitor, and so on.

Especially, when the subject motion sensor is installed in the PC video communication camera, motion picture data of image and sound of the subject as well as the subject motion data information within the proximity distance in front of the host computer may also be recorded and stored, similar to the case of using the CCTV camera. At this time, while the image sensor in the PC video communication camera may be used in the subject motion sensor, since the image sensor has large power consumption, the exclusive subject motion sensor may be preferably employed.

In addition, an electromagnetic sensor such as a capaciflector sensor as well as an optical sensor such as an infrared motion sensor may be adapted to the subject motion sensor having a computer security function in accordance with the present invention. The capaciflector sensor has a structure in which a reflector plate is interposed between two electrodes of a sensing substrate and a ground substrate such that an electric field is formed from one electrode to the other electrode to surround the exterior thereof, thereby detecting an approach to the capaciflector sensor using the electric field.

For convince of explanation of this patent, optical mouse is used. But, it natural to apply to any computer input devices such as joystick, digitizer, touchpad, and pen input.

As can be seen from the foregoing, when a subject motion sensor having a computer security function is installed in a host computer or a computer input device, it is possible to prevent degradation of image quality due to deterioration of a video security system by conventional recording media, limitation of a record time, and waste of maintenance cost and manpower for storing the recording media. In particular, when the sensor is installed in an optical mouse, it is possible to prevent complication of a circuit and increase in manufacturing cost due to separate electrical or optical components.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A computer system having a security function comprising:
a host computer for operating a first security program when motion data of a subject is received in a non-operation state that power is applied and a computer does not operate;
a computer input device for applying an input signal to the host computer to perform an operation corresponding thereto; and
a subject motion sensor for detecting a motion of the subject to output motion data of the subject.

2. The computer system according to claim 1, wherein the host computer operates a second security program when the motion data of the subject is not received in an operation state that the power is applied and the computer operates

3. The computer system according to claim 1, wherein the non-operation state is a state in which the host computer is in a standby mode to save power of the computer system when the computer operation is not performed for a predetermined time in a state that the power is applied to the host computer.

4. The computer system according to claim 1, wherein the subject motion sensor is installed in the host computer, the computer input device, or a computer monitor to detect the motion of the subject.

5. The computer system according to claim 1, wherein the subject motion sensor uses an optical sensor such as an infrared motion sensor or an electromagnetic sensor such as a capaciflector sensor.

6. The computer system according to claim 1, wherein the computer input device is a computer auxiliary device such as a mouse, a keyboard, or a PC video communication camera.

7. The computer system according to claim 1, wherein the computer input device comprises a power supply installed therein so that a power voltage is supplied from the host computer when the power is applied to the host computer, and a power voltage is supplied from the power supply when the power is not applied to the host computer.

8. The computer system according to claim 1, wherein the first security program is a program for determining that an illegal intruder operates the host computer to inform the illegal intrusion to a predetermined security company.

9. The computer system according to claim 2, wherein the second security program is a program for determining that an authorized user of the host computer stops a computer operation and leaves the seat for a long time to limit data transmission/reception through a network, or setting a password for preventing access to the host computer through a remote login by the illegal intruder.

10. The computer system according to claim 1, wherein the subject motion data comprises a moved time or a consumed time of the subject.

11. The computer system according to claim 1, wherein, when the computer system comprises a PC video communication camera and the subject motion sensor is installed in the PC video communication camera, the subject motion data comprises a moved time or a consumed time of the subject, and a moving picture data of shape and sound of the subject.

12. A computer security method comprising:
a first step of determining whether a host computer currently operates in a state that power is applied to the host computer;
a second step of determining that the host computer does not currently operate in the first step and operating a subject motion sensor to determine whether a motion of a subject is detected, when the power is applied to the host computer and the host computer does not operate for a predetermined time; and
a third step of operating the host computer to operate a first security program when the motion of the subject is detected.

13. The computer security method according to claim 12, further comprising:
a fourth step of determining that the host computer currently operates and determining whether an input signal is input into the host computer from a computer input device, when power is applied to the host computer and the host computer operates in the first step;
a fifth step of receiving an input signal and performing an operation in response to the signal when it is determined that the input signal is input into the host computer in the fourth step; and
a sixth step of operating the subject motion sensor to determine whether a motion of the subject is detected when there is no input signal in the fourth step.

14. The computer security method according to claim 12, further comprising:
a seventh step of feeding back to the fourth step when the motion of the subject is detected in the sixth step, and feeding back to the fourth step after operating a second security program when the motion of the subject is not detected in the sixth step.

15. The computer security method according to claim 13, wherein the fifth step comprises:
feeding back to the fourth step by determining that an authorized user uses the host computer when the motion of the subject is detected; and
operating the first security program to prevent access to the host computer through a computer network by an illegal intruder when the motion of the subject is not detected.

16. The computer security method according to claim 12, wherein the first security program is a program for determining that an authorized user of the host computer stops a computer operation and leaves the seat for a long time to limit data transmission/reception through a network, or setting a password for preventing access to the host computer through a remote login by the illegal intruder.

17. The computer security method according to claim 14, wherein the second security program is a program for determining that an illegal intruder operates the host computer to inform the illegal intrusion to a predetermined security company.

18. The computer security method according to claim 12, wherein the subject motion sensor detects an approach or motion of the subject within a proximity range of the host computer to output motion data such as a moved time or a consumed time of the subject.

19. An optical pointing device comprising:
an optical part for irradiating light to a worktable surface using a light source and transmitting the light reflected from the worktable surface;
a motion sensor for receiving the reflected light to continuously detect an image of the worktable surface and detect a motion of the optical pointing device using variation of the image, and calculating a motion value to output motion data;
a first transparent plate for simultaneously receiving the reflected light to discharge the light to the exterior of the optical pointing device;
a second transparent plate for transmitting the light discharged from the first transparent plate and reflected from the subject into the optical pointing device;
a subject motion sensor for receiving the light reflected from the subject through the second transparent plate to detect a motion of the subject, and outputting subject motion data; and
a motion data storage part for receiving the motion data and the subject motion data and storing the data.

20. The optical pointing device according to claim 19, further comprising a wireless data transmission and reception part for receiving a motion data transmission request from the host computer, and receiving the data stored in the motion data storage part to transmit the data to the host computer.

21. The optical pointing device according to claim 19, wherein the subject motion data is motion data such as a moved time or a consumed time of the subject.

22. The optical pointing device according to claim 19, wherein the subject motion sensor uses an optical sensor such as an infrared motion sensor or an electromagnetic sensor such as a capaciflector sensor.
